(19) United States
(12) Patent Application Publication
(10) Pub. No.: US 2026/0027529 A1
(43) Pub. Date: Jan. 29, 2026

(54) FINE BUBBLE GENERATOR, WATER HEATER, AND DISHWASHER

(71) Applicant: RINNAI CORPORATION, Nagoya-shi, Aichi (JP)

(72) Inventors: Shoji AOKI, Nagoya-shi, Aichi-ken (JP); Kazuki MATSUEDA, Nagoya-shi, Aichi-ken (JP); Shinya FURUKAWA, Nagoya-shi, Aichi-ken (JP); Ikko AMAMIYA, Nagoya-shi, Aichi-ken (JP)

(73) Assignee: RINNAI CORPORATION, Nagoya-shi, Aichi (JP)

(21) Appl. No.: 18/845,455

(22) PCT Filed: Oct. 20, 2022
(86) PCT No.: PCT/JP2022/039063

§ 371 Date: Mar. 19, 2025

(30) Foreign Application Priority Data
Mar. 28, 2022 (JP) 2022-052188

(51) Int. Cl. B01F 23/2373; A47L 15/10; B01F 25/432; F24H 9/00

(52) U.S. Cl. CPC B01F 23/2373; A47L 15/10; B01F 25/432; F24H 9/0005

(57) ABSTRACT

A fine bubble generator disclosed herein may include a body casing having an inlet and an outlet and a first fine bubble generation portion housed in the body casing. The first fine bubble generation portion may include a body portion, a venturi flow path through the body portion, an upstream fitting portion connected to the body portion and substantially fit an inner surface of the body casing, and a downstream fitting portion connected to the body portion downstream of the upstream fitting portion and substantially fit the inner surface of the body casing. A liquid drainage flow path connecting a gap space to the outlet may be disposed in the body casing, wherein the gap space may be defined between the inner surface of the body casing and an outer surface of the body portion and between the upstream fitting portion and the downstream fitting portion.

### TECHNICAL FIELD

The art disclosed herein relates to a fine bubble generator, a water heater, and a dishwasher.

### BACKGROUND ART

Japanese Patent Application Publication No. 2010-201397 describes a fine bubble generator including a body casing having an inlet and an outlet, and a first fine bubble generation portion housed in the body casing. The first fine bubble generation portion includes: a body portion extending between the inlet and the outlet; a venturi flow path connecting the inlet and the outlet through the body portion; an upstream fitting portion connected to an upstream end of the body portion and including an outer surface having a shape that substantially fits an inner surface of the body casing when an interior of the body casing is viewed from an upstream side; and a downstream fitting portion connected to a downstream end of the body portion and including an outer surface having a shape that substantially fits the inner surface of the body casing when the interior of the body casing is viewed from a downstream side. The venturi flow path includes: a diameter-decreasing flow path of which flow path diameter decreases from upstream to downstream; and a diameter-increasing flow path which is disposed downstream of the diameter-decreasing flow path and of which flow path diameter increases from upstream to downstream. A gap space is disposed in the body casing, in which the gap space is defined between the inner surface of the body casing and an outer surface of the body portion and between the upstream fitting portion and the downstream fitting portion.

### SUMMARY OF INVENTION

### Technical Problem

In a fine bubble generator such as the one described in Japanese Patent Application Publication No. 2010-201397, an upstream fitting portion and a downstream fitting portion are provided to stabilize the posture of the first fine bubble generation portion in the body casing. However, due to the upstream fitting portion and the downstream fitting portion being provided, the performance to drain liquid that entered the gap space could be deteriorated. In this case, liquid puddle may occur in the gap space after the drainage of the fine bubble generator is performed, and malfunctions (e.g., damage to the casing due to frozen liquid puddle) may occur. The disclosure herein provides a technique that can improve a drainage performance of a gap space.

### Solution to Technical Problem

A fine bubble generator disclosed herein may comprise a body casing having an inlet and an outlet and a first fine bubble generation portion housed in the body casing. The first fine bubble generation portion may comprise a body portion extending between the inlet and the outlet, a venturi flow path connecting the inlet and the outlet through the body portion, an upstream fitting portion connected to an upstream end of the body portion and including an outer surface having a shape that substantially fits an inner surface of the body casing when an interior of the body casing is viewed from an upstream side, and a downstream fitting portion connected to a downstream end of the body portion and including an outer surface having a shape that substantially fits the inner surface of the body casing when the interior of the body casing is viewed from a downstream side. The venturi flow path may comprise a diameter-decreasing flow path of which flow path diameter decreases from upstream to downstream and a diameter-increasing flow path which is disposed downstream of the diameter-decreasing flow path and of which flow path diameter increases from upstream to downstream. A gap space and one or more liquid drainage flow paths may be disposed in the body casing, wherein the gap space may be defined between the inner surface of the body casing and an outer surface of the body portion and between the upstream fitting portion and the downstream fitting portion, and each of the one or more liquid drainage flow paths connects the gap space to the outlet.

According to the above configuration, when the fine bubble generator is drained so that liquid in the body casing drains from the inlet to the outlet, the liquid in the gap space drains through the one or more liquid drainage flow paths to the outlet. Due to this, the draining performance of the gap space can be improved.

In one or more embodiments, the liquid drainage flow paths may comprise a plurality of liquid drainage flow paths and comprise a first liquid drainage flow path and a second liquid drainage flow path.

According to the above configuration, when the fine bubble generator is drained so that the liquid in the body casing drains from the inlet to the outlet, the liquid in the gap space drains from multiple locations to the outlet. Due to this, the draining performance of the gap space can further be improved.

In one or more embodiments, at least one of the one or more liquid drainage flow paths may be connected to the gap space at a lowest part of the gap space or in a vicinity thereof when a lower side is defined with respect to a vertically downward direction.

Normally, when the fine bubble generator is drained, the liquid in the gap space drains downward by gravity. Due to this, especially at the lowest part of the gap space or in the vicinity thereof, liquid puddle tends to occur after drainage of the fine bubble generator. According to the above configuration, at least one liquid drainage flow path is connected to the gap space at the lowest part of the gap space or in the vicinity thereof when the lower side is defined with respect to the vertically downward direction. This ensures to suppress occurrence of the liquid puddle in the gap space after drainage of the fine bubble generator.

In one or more embodiments, the fine bubble generator may further comprise a second fine bubble generation portion housed in the body casing and disposed between the first fine bubble generation portion and the outlet. The second fine bubble generation portion may comprise a shaft portion extending in a direction from upstream to downstream, an outer circumference portion surrounding an outside of the shaft portion in a radial direction, a plurality of vanes disposed between the shaft portion and the outer circumference portion and configured to generate a swirling flow flowing in a predetermined swirling direction with respect to the shaft portion, and a swirling flow path extending through a space between the shaft portion, the outer circumference portion, and the plurality of vanes.

According to the above configuration, the second fine bubble generation portion is further provided downstream of the first fine bubble generation portion. Therefore, the liquid flowing into the inlet not only passes through the venturi flow path of the first fine bubble generation portion, but also through the swirling flow path of the second fine bubble generation portion. In this case, the fine bubbles generated in the first fine bubble generation portion become finer and the amount of fine bubbles increases due to the shear force by the swirling flow generated in the second fine bubble generation portion. According to the above configuration, a large amount of fine bubbles can be generated.

In one or more embodiments, the body casing may include an inner surface having a substantially cylinder shape extending in a direction from upstream to downstream. The first fine bubble generation portion may be constituted of a plastic. The body portion may include a diameter-decreasing outer surface of which diameter decreases from upstream to downstream at a portion where the diameter-decreasing flow path is disposed. The body portion may include a diameter-increasing outer surface of which diameter increases from upstream to downstream at a portion where the diameter-increasing flow path is disposed.

When plastic is used for the first fine bubble generation portion, the first fine bubble generation portion is generally formed by injection molding. In this case, if a wall thickness of the first fine bubble generation portion (especially the body portion) is large, qualitative defects of the first fine bubble generation portion are likely to occur. Contrary to this, according to the above configuration, the wall thickness of the body portion can be reduced. Therefore, when the first fine bubble generation portion is formed by injection molding, quality of the first fine bubble generation portion can be improved. Furthermore, according to the above configuration, a volume of the gap space is increased, and the effect of improving the drainage performance of the gap space achieved by the present application becomes more remarkable.

In one or more embodiments, one or more notches may be disposed in the first fine bubble generation portion, each of the notches is defined by removing a portion of the downstream fitting portion from downstream to upstream. The one or more notches may serve as the one or more liquid drainage flow paths.

According to the above configuration, the one or more liquid drainage flow paths can be defined by partially processing the first fine bubble generation portion. Therefore, one or more liquid drainage flow paths can easily be defined.

In one or more embodiments, one or more recesses may be disposed in the first fine bubble generation portion, each of the recesses has a shape recessed inwardly from the outer surface of the body portion. The one or more recesses may be connected to the one or more notches.

According to the above configuration, the one or more recesses make it easier for the liquid in the gap space to be directed to the one or more notches. That is, the liquid in the gap space tends to be directed to the one or more liquid drainage flow paths. The drainage performance of the gap space can further be improved.

A water heater disclosed herein may comprise the fine bubble generator disclosed above.

According to the above configuration, the drainage performance of the gap space can be improved in the fine bubble generator included in the water heater.

A dishwasher disclosed herein may comprise the fine bubble generator disclosed above.

According to the above configuration, the drainage performance of the gap space can be improved in the fine bubble generator included in the dishwasher.

### BRIEF DESCRIPTION OF DRAWINGS

FIG. 1 schematically shows a configuration of a water heater 100 of a first embodiment;

FIG. 2 is a perspective view of an entirety of a fine bubble generator 2 of first and second embodiments;

FIG. 3 is a cross-sectional view of the fine bubble generator 2 of the first and second embodiments;

FIG. 4 is a perspective view of an entirety of a first fine bubble generation portion 3 included in the fine bubble generator 2 of the first and second embodiments;

FIG. 5 is a cross-sectional view along a line V-V in FIG. 3;

FIG. 6 is a cross-sectional view along a line VI-VI in FIG. 3;

FIG. 7 is a view seeing one of a second fine bubble generation portions 5 included in the fine bubble generator 2 of the first and second embodiments as viewed from the upstream side;

FIG. 8 is a view seeing the second fine bubble generation portions 5 included in the fine bubble generator 2 of the first and second embodiments as viewed along a direction perpendicular to a central axis A;

FIG. 9 shows an example of installation of the fine bubble generator 2 of the first and second embodiments; and

FIG. 10 schematically shows a configuration of a dishwasher 510 of the second embodiment.

### DESCRIPTION OF EMBODIMENTS

### First Embodiment: Water Heater 100 Including Fine Bubble Generator 2

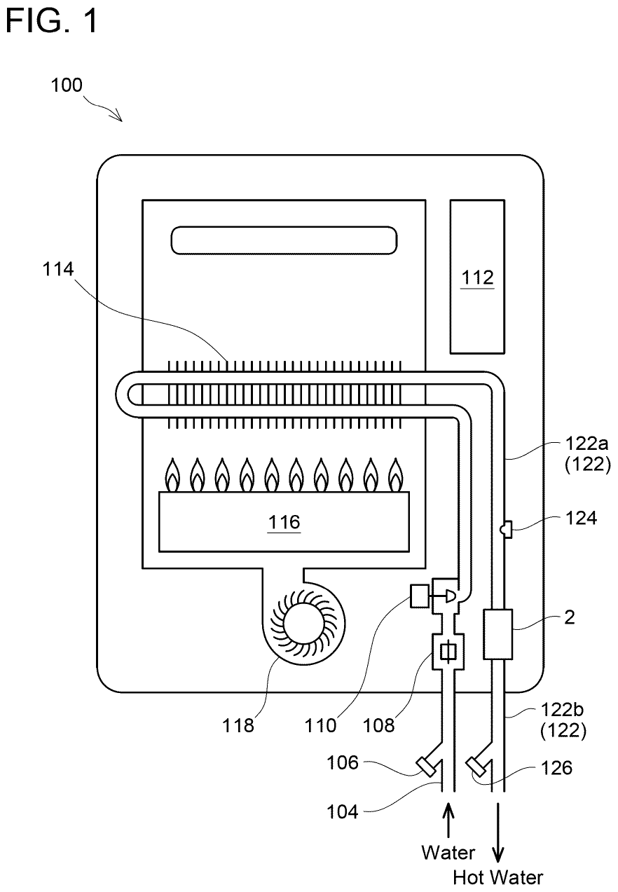

As shown in FIG. 1, a water heater 100 includes a fine bubble generator 2, a water supply pipe 104, a first water drain valve 106, a water volume sensor 108, a water volume servo 110, a water heater controller 112, a heat exchanger 114, a gas burner 116, a combustion fan 118, a hot water pipe 122, a hot water thermistor 124, and a second water drain valve 126.

The upstream end of the water supply pipe 104 is connected to a water supply source such as a water supply system. The first water drain valve 106, the water volume sensor 108, and the water volume servo 110 are disposed on the water supply pipe 104 in this order from the upstream end. The water volume sensor 108 detects a flow rate of water flowing through the water supply pipe 104. The water volume servo 110 switches between open and closed states to allow or prohibit water flow. A volume of the water flowing through the water volume servo 110 in the open state varies according to the degree of opening of the water volume servo 110. In this embodiment, the water supplied from the water source (e.g., tap water) contains dissolved air (oxygen, carbon dioxide, nitrogen, etc.).

The upstream end of the heat exchanger 114 is connected to the downstream end of the water supply pipe 104. The gas burner 116 heats the water flowing in the heat exchanger 114 by burning supplied combustion gas. The downstream end of the heat exchanger 114 is connected to the upstream end of the hot water pipe 122. The hot water thermistor 124, the fine bubble generator 2, and the second water drain valve 126 are provided on the hot water pipe 122 in this order from the upstream end. The hot water thermistor 124 detects a temperature of the water flowing through the hot water pipe 122. The downstream end of the hot water pipe 122 is connected to a hot water outlet, such as a hot water basin or a bathtub. In the following, the hot water pipe 122 connecting to the upstream end of the fine bubble generator 2 is referred to as the “first hot water pipe 122a”, and the hot water pipe 122 connecting to the downstream end of the fine bubble generator 2 is referred to as the “second hot water pipe 122b”.

The water heater controller 112 includes a CPU, ROM, RAM, etc. Information on the water flow rate detected by the water volume sensor 108 and the water temperature detected by the hot water thermistor 124 are sent to the water heater controller 112. The water heater controller 112 can adjust a water volume flowing into the heat exchanger 114 from the water supply pipe 104 by adjusting the degree of opening of the water volume servo 110. Further, the water heater controller 112 can also adjust heating power of the gas burner 116 by adjusting an amount of the combustion gas supplied to the gas burner 116. The water heater controller 112 can adjust the temperature of the water flowing through the hot water pipe 122 to a desired temperature by controlling operations of the water volume servo 110 and the gas burner 116 based on the information detected by the water volume sensor 108 and the hot water thermistor 124.

### Configuration of Fine Bubble Generator 2

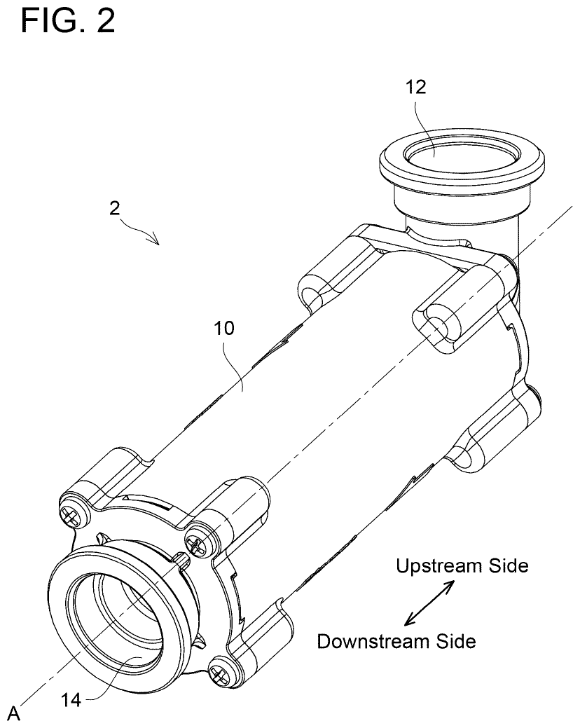

As shown in FIG. 2, the fine bubble generator 2 includes a body casing 10, an inlet 12, and an outlet 14. The body casing 10 has a substantially cylindrical shape about a central axis A. The inlet 12 and the outlet 14 are fastened to the body casing 10 by screws. The inlet 12 is connected to the downstream end of the first hot water pipe 122a (see FIG. 1). The outlet 14 is connected to the upstream end of the second hot water pipe 122b (see FIG. 1). Due to this, the water entering from the first hot water pipe 122a flows into the inlet 12, passes through the body casing 10, and flows out of the outlet 14 into the second hot water pipe 122b.

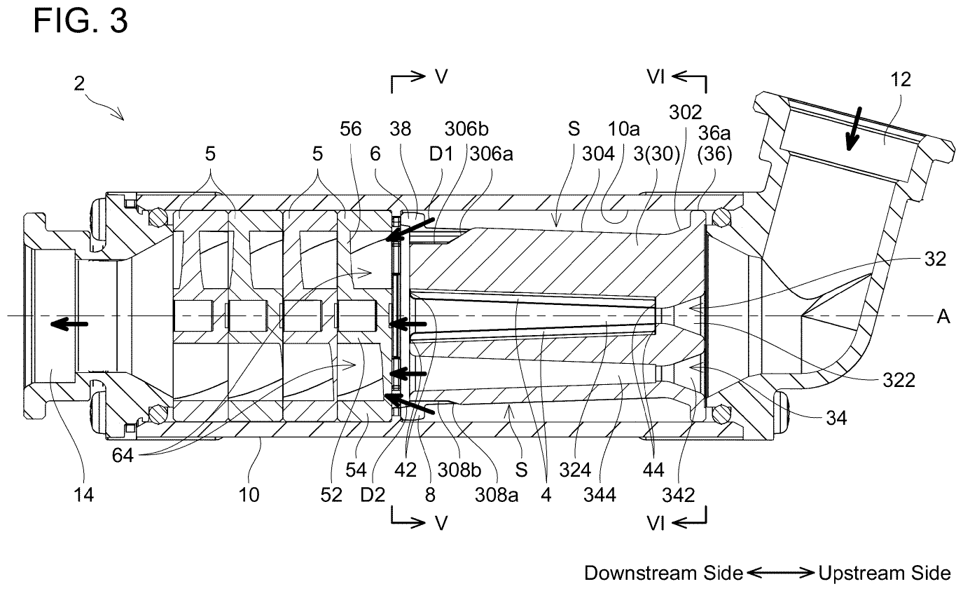

As shown in FIG. 3, the body casing 10 houses a first fine bubble generation portion 3 and a plurality of second fine bubble generation portions 5. The first fine bubble generation portion 3 and the plurality of second fine bubble generation portions 5 are disposed along the central axis A. The plurality of second fine bubble generation portions 5 is arranged downstream of the first fine bubble generation portion 3. In this embodiment, the plurality of second fine bubble generation portions 5 includes four second fine bubble generation portions 5. All of the second fine bubble generation portions 5 have the same shape.

### Configuration of First Fine Bubble Generation Portion 3

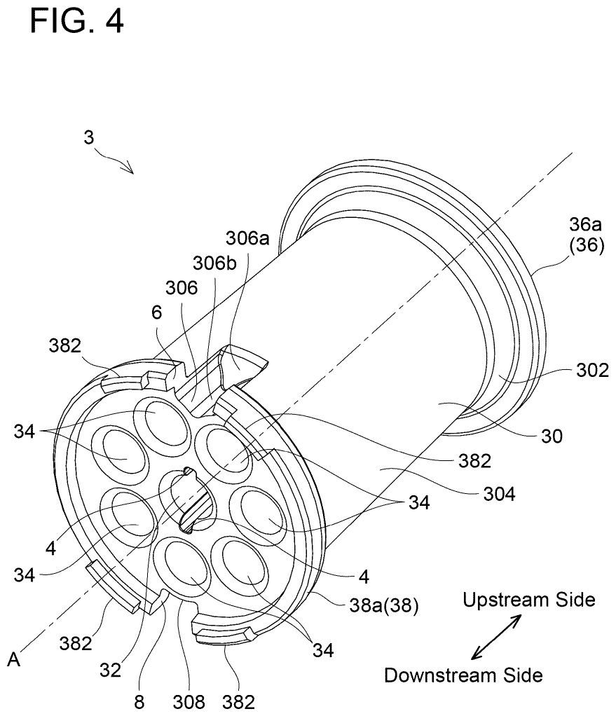

As shown in FIG. 4, the first fine bubble generation portion 3 has a substantially rotator shape about the central axis A. The first fine bubble generation portion 3 includes a body portion 30, an inner venturi flow path 32, a plurality of outer venturi flow paths 34, an upstream fitting portion 36, and a downstream fitting portion 38. In this embodiment, the first fine bubble generation portion 3 is formed as a unit by injection molding using plastic (e.g., polypropylene or polyphenylene sulfide). Due to this, the body portion 30, the upstream fitting portion 36, and the downstream fitting portion 38 are seamlessly formed as a unit. As shown in FIG. 3, the body portion 30 extends between inlet 12 and outlet 14 and includes a diameter-decreasing outer surface 302 of which diameter decreases from upstream to downstream along the central axis A, and a diameter-increasing outer surface 304 which connects to the downstream end of the diameter-decreasing outer surface 302 and of which diameter increases from upstream to downstream along the central axis A.

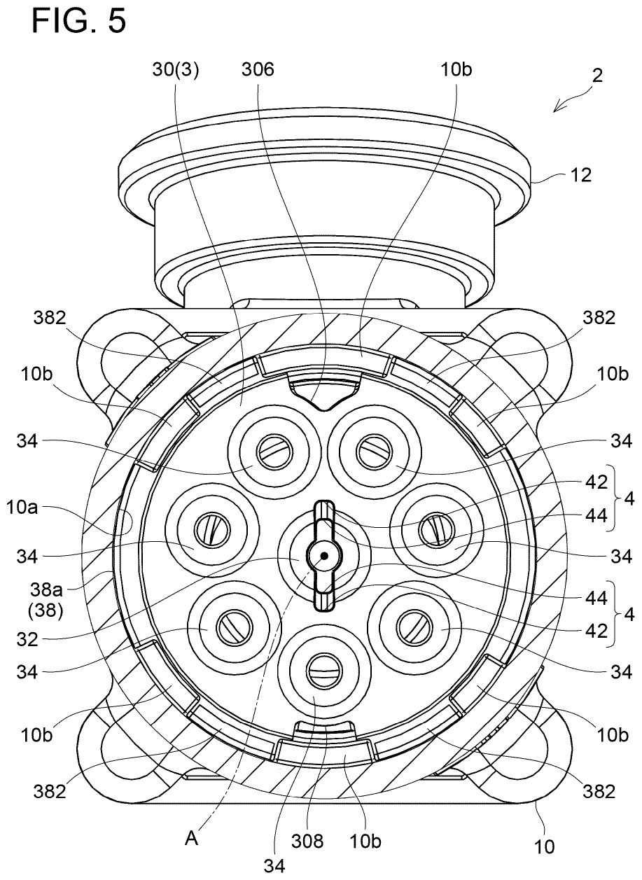

A first recess 306 and a second recess 308 each having a shape recessed inwardly from the diameter-increasing outer surface 304 along the radial direction of the central axis A are provided at the downstream end of the body portion 30 or in the vicinity thereof. As shown in FIG. 5, the first recess 306 and the second recess 308 are provided at a depth that does not interfere with the plurality of outer venturi flow paths 34. The first recess 306 and the second recess 308 are spaced 180° from each other in the circumferential direction of the central axis A. The first recess 306 and the second recess 308 are provided to extend upstream from the downstream end of the body portion 30.

As shown in FIG. 3, the first recess 306 includes a first tilted portion 306a that slopes to approach the central axis A from upstream to downstream, and a first bottom portion 306b that is connected to the first tilted portion 306a and extends along the central axis A. The first tilted portion 306a smoothly connects the diameter-increasing outer surface 304 with the first bottom portion 306b. The second recess 308 includes a second tilted portion 308a that slopes to approach the central axis A from upstream to downstream, and a second bottom portion 308b that is connected to the second tilted portion 308a and extends along the central axis A. The second tilted portion 308a smoothly connects the diameter-increasing outer surface 304 with the second bottom portion 308b.

The inner venturi flow path 32 and the plurality of outer venturi flow paths 34 extend inside the body portion 30 and connect the inlet 12 and the outlet 14. The inner venturi flow path 32 extends on the central axis A. As shown in FIG. 4, the plurality of outer venturi flow paths 34 is arranged around the inner venturi flow path 32. In this embodiment, the plurality of outer venturi flow paths 34 includes seven outer venturi flow paths 34. The plurality of outer venturi flow paths 34 is arranged at predetermined angular intervals (in this embodiment, at about 51° intervals) in the circumferential direction of the central axis A.

As shown in FIG. 3, the inner venturi flow path 32 includes an inner diameter-decreasing flow path 322 of which flow path diameter decreases along the central axis A from upstream to downstream, and an inner diameter-increasing flow path 324 disposed downstream of the inner diameter-decreasing flow path 322 and of which flow path diameter increases along the central axis A from upstream to downstream.

As shown in FIG. 5, a plurality of slits 4 is defined in the inner venturi flow path 32, and the slits 4 are recessed outward in the radial direction of the central axis A from the inner surface of the inner venturi flow path 32. In this embodiment, the plurality of slits 4 includes two slits 4. The plurality of slits 4 is arranged in the circumferential direction of the central axis A at predetermined angular intervals (180° intervals in this embodiment). In other words, the plurality of slits 4 is arranged to face each other on the inner surface of the inner venturi flow path 32. Each of the plurality of slits 4 is arranged continuously from a first end 42, which coincides with the downstream end of the inner diameter-increasing flow path 324, to a second end 44, which is located upstream of the downstream end of the inner diameter-increasing flow path 324. Each of the plurality of slits 4 has a substantially constant width in a direction perpendicular to a recessing direction. The width of the plurality of slits 4 ranges from 0.5 mm to 3.0 mm, for example, and is 1.5 mm in this embodiment. The plurality of slits 4 is provided only in the inner venturi flow path 32 and none in the plurality of outer venturi flow paths 34.

As shown in FIG. 3, the second end 44 is located downstream of the downstream end of the inner diameter-decreasing flow path 322. In this embodiment, the second end 44 coincides with the upstream end of the inner diameter-increasing flow path 324. Each of the plurality of slits 4 has a substantially constant depth in the radial direction of the central axis A. The depth of the plurality of slits 4 ranges from 0.5 mm to 3.0 mm, for example, and is 1.8 mm in this embodiment. Each of the plurality of slits 4 is provided to extend substantially linearly from the first end 42 to the second end 44. Further, as shown in FIG. 4, the downstream end of the inner diameter-increasing flow path 324 has a bell-mouth shape. Due to this, peripheries of the plurality of slits 4 at and in the vicinity of the first end 42 each have a curved shape along the bell-mouth shape of the inner diameter-increasing flow path 324.

As shown in FIG. 3, each of the plurality of outer venturi flow paths 34 includes an outer diameter-decreasing flow path 342 of which flow path diameter decreases from upstream to downstream, and an outer diameter-increasing flow path 344 of which flow path diameter increases from upstream to downstream, and the outer diameter-increasing flow path 344 is arranged downstream of the outer diameter-decreasing flow path 342. The downstream end of the outer diameter-increasing flow path 344 has a bell-mouth shape. All of the plurality of outer venturi flow paths 34 have the same shape.

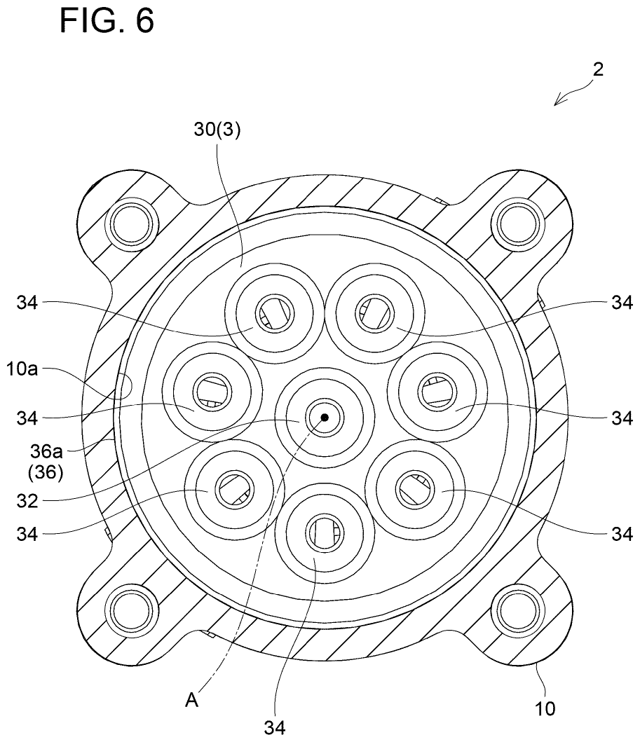

As shown in FIG. 4, the upstream fitting portion 36 has a flange shape projecting outward in the radial direction of the central axis A from the upstream end of the body portion 30. The upstream fitting portion 36 includes an outer surface 36a that expands in the circumferential direction of the central axis A. As shown in FIG. 6, when the interior of the body casing 10 is viewed from the upstream side, the outer surface 36a of the upstream fitting portion 36 substantially fits the inner surface 10a of the body casing 10 over the entire inner surface 10a of the body casing 10. Due to this, a mechanical seal is provided between the outer surface 36a of the upstream fitting portion 36 and the inner surface 10a of the body casing 10.

As shown in FIG. 4, the downstream fitting portion 38 protrudes outward in the radial direction of the central axis A from the downstream end of the body portion 30 and extends along the central axis A toward the downstream side beyond the downstream end of the body portion 30. The downstream fitting portion 38 includes, at its downstream end, engagement protrusions 382 partially protruding downstream. A first notch 6 and a second notch 8 formed by removing parts of the downstream fitting portion 38 from downstream to upstream are defined in the first fine bubble generation portion 3. The first notch 6 is smoothly connected to the first recess 306 of the body portion 30. The second notch 8 is smoothly connected to the second recess 308 of the body portion 30.

As shown in FIG. 5, when the interior of the body casing 10 is viewed from the downstream side, the outer surface 38a of the downstream fitting portion 38 substantially fits the inner surface 10a of the body casing 10 over the entire inner surface 10a of the body casing 10, except for an area where the first notch 6 and second notch 8 are defined. In addition, the engagement protrusions 382 engage from the upstream side with positioning members 10b, which protrudes inward from the inner surface 10a of the body casing 10. As a result, the first fine bubble generation portion 3 is housed in the body casing 10 with the first fine bubble generation portion 3 positioned with respect to the body casing 10 in the axial and circumferential directions of the central axis A.

As shown in FIG. 3, a gap space S is defined between the inner surface 10a of the body casing 10 and the diameter-decreasing outer surface 302 and the diameter-increasing outer surface 304 of the body portion 30, and between the upstream fitting portion 36 and the downstream fitting portion 38. Due to the presence of the mechanical seal between the outer surface 36a of the upstream fitting portion 36 and the inner surface 10a of the body casing 10, entry and exit of water is suppressed on the upstream side of the gap space S. On the other hand, on the downstream side of the gap space S, a first water drainage flow path D1 formed by the first notch 6 and the first recess 306 and a second water drainage flow path D2 formed by the second notch 8 and the second recess 308 allow entry and exit of water. Due to this, the gap space S is connected to the outlet 14 via the first water drainage flow path D1 and the second water drainage flow path D2.

### Configuration of Second Fine Bubble Generation Portions 5

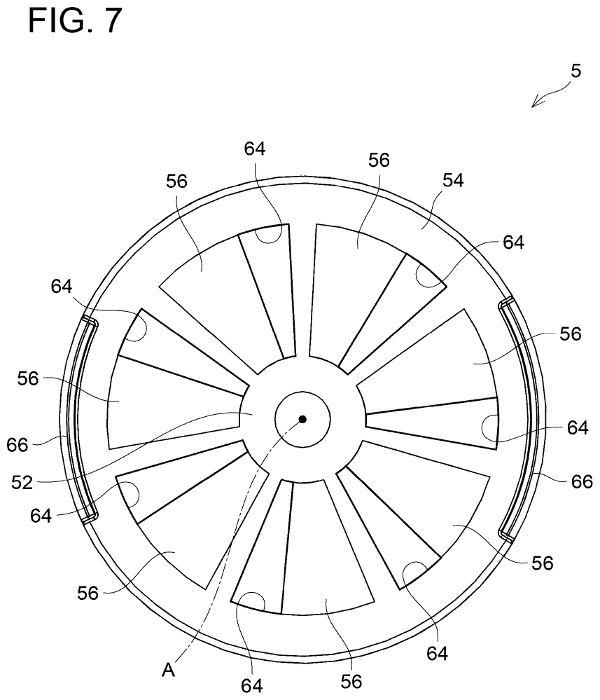

As shown in FIG. 7, each of the second fine bubble generations portion 5 includes a shaft portion 52, an outer circumference portion 54 surrounding the shaft portion 52, and a plurality of vanes 56 disposed between the shaft portion 52 and the outer circumference portion 54 and configured to generate a swirling flow flowing in a clockwise direction with respect to the shaft portion 52. The “clockwise direction” and “counterclockwise direction” described herein refer to the directions when the fine bubble generator 2 is viewed from the upstream side along the central axis A. The second fine bubble generation portion 5 is made of plastic (e.g., polypropylene or polyphenylene sulfide) as a unit by injection molding. Due to this, the shaft portion 52, the outer circumference portion 54, and the plurality of vanes 56 are seamlessly formed as one unit.

The shaft portion 52 has a round columnar shape. The outer circumference portion 54 has a cylindrical shape. The outer circumference portion 54 has an outer surface that substantially fits the inner surface 10a of the body casing 10. Further, the shaft portion 52 and the outer circumference portion 54 are provided along the central axis A. The plurality of vanes 56 connects the outer wall of the shaft portion 52 and the inner wall of the outer circumference portion 54. The plurality of vanes 56 is tilted to the downstream side in the clockwise direction. In this embodiment, the plurality of vanes 56 includes seven vanes 56. The plurality of vanes 56 is arranged at predetermined angular intervals (in this embodiment, at about 51° intervals) in the circumferential direction of the central axis A. Further, in the second fine bubble generation portion 5, seven swirling flow paths 64 (bold lines in FIG. 7) are defined. Each of the seven swirling flow paths 64 is provided in the gap between the shaft portion 52, the outer circumference portion 54, and the plurality of vanes 56.

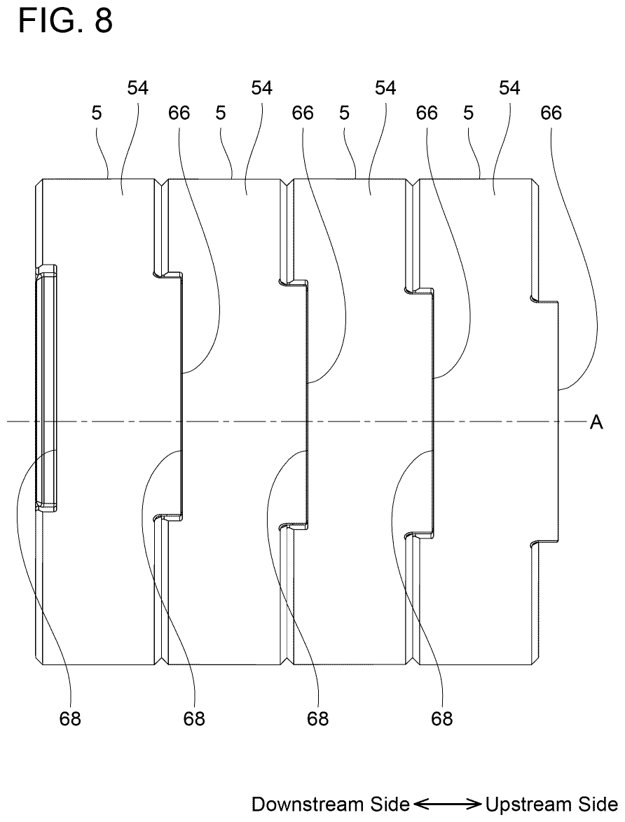

As shown in FIG. 8, each of the outer circumference portions 54 includes, at its upstream end, fitting protrusions 66 protruding partially upstream. The outer circumference portion 54 includes, at its downstream end, fitting recesses 68 recessed partially upstream. The fitting protrusions 66 and the fitting recesses 68 are shaped to fit with each other.

Looking at the two second fine bubble generation portions 5 positioned adjacent to each other, the fitting protrusions 66 of the downstream second fine bubble generation portion 5 fit the fitting recesses 68 of the upstream second fine bubble generation portion 5. Due to this, the plurality of second fine bubble generation portions 5 is positioned with respect to each other. Further, the fitting protrusions 66 of the upstream-most second fine bubble generation portion 5 are engaged with the positioning members 10b (see FIG. 5) of the body casing 10 from the downstream side. As described above, each of the plurality of second fine bubble generation portions 5 is accommodated in the body casing 10 in the state of being positioned in the circumferential direction of the central axis A with respect to the body casing 10.

### Principle of Fine Bubble Generation

As shown in FIG. 1, since air is dissolved in the water supplied from the water source, air is also dissolved in the water flowing through the first hot water pipe 122a. Therefore, the water with the air dissolved in it flows into the fine bubble generator 2 from the first hot water pipe 122a. Hereafter, the water in which air is dissolved is referred to as “air-dissolved water”.

As shown in FIG. 3, the air-dissolved water flowing from the inlet 12 into the body casing 10 flows into the diameter-decreasing flow paths 322 and 342 of the venturi flow paths 32 and 34. Flowing velocity of the air-dissolved water that has entered the diameter-decreasing flow paths 322 and 342 increases as it flows in the diameter-decreasing flow paths 322 and 342, and as a result, the water is depressurized. Air bubbles are generated by the air-dissolved water being depressurized. The air-dissolved water that flowed through the diameter-decreasing flow paths 322, 342 flows into the diameter-increasing flow paths 324, 344. The flowing velocity of the air-dissolved water that has entered the diameter-increasing flow paths 324, 344 decreases as it flows in the diameter-increasing flow paths 324, 344, and as a result, the water is pressurized. When the air-dissolved water in which the air bubbles have been generated by the depressurization is pressurized, the air bubbles in the air-dissolved water further break into fine bubbles. In this disclosure, the inner venturi flow path 32 and the plurality of outer venturi flow paths 34 may collectively be referred to as “venturi flow paths 32 and 34”. Similarly, the inner diameter-decreasing flow path 322 and the outer diameter-decreasing flow paths 342 may be referred collectively as “diameter-decreasing flow paths 322, 342”. Similarly, the inner diameter-increasing flow path 324 and the outer diameter-increasing flow paths 344 may collectively be referred to as “diameter-increasing flow paths 324, 344”.

The air-dissolved water that flows through the diameter-increasing flow paths 324 and 344 and out of the first fine bubble generation portion 3 flows toward the upstream-most second fine bubble generation portion 5. At this occasion, the air-dissolved water that flowed out of the inner venturi flow path 32 collides with the upstream end of the shaft portion 52 of the upstream-most second fine bubble generation portion 5, and is pushed outward in the radial direction of the central axis A and flows into the swirling flow paths 64. On the other hand, the air-dissolved water that flows out of the outer venturi flow paths 34 flows into the swirling flow paths 64 without colliding with the shaft portion 52. Thereafter, the air-dissolved water passes through the respective swirling flow paths 64 of the second fine bubble generation portions 5 from upstream to downstream. The air-dissolved water flowing along the swirling flow paths 64 becomes a swirling flow flowing in the clockwise direction as it flows along the vanes 56. The fine bubbles in the air-dissolved water become finer and the amount of the fine bubbles increases due to a shearing force of the swirling flow. Then, the air-dissolved water flowing out of the swirling flow paths 64 of the downstream-most second fine bubble generation portions 5 is directed to the outlet 14. As above, the water heater 100 (see FIG. 1) supplies hot water containing many fine bubbles to the hot water outlet.

### Drainage Mechanism of Fine Bubble Generator 2

As shown in FIG. 1, the drainage of the fine bubble generator 2 can be performed by opening the first water drain valve 106 and the second water drain valve 126. When the first water drain valve 106 and the second water drain valve 126 are open, the water between the first water drain valve 106 and the second water drain valve 126 flows by gravity and flows out from the first water drain valve 106 or the second water drain valve 126. In doing so, in the fine bubble generator 2, the water drains from the inlet 12 toward the outlet 14 (see FIG. 3).

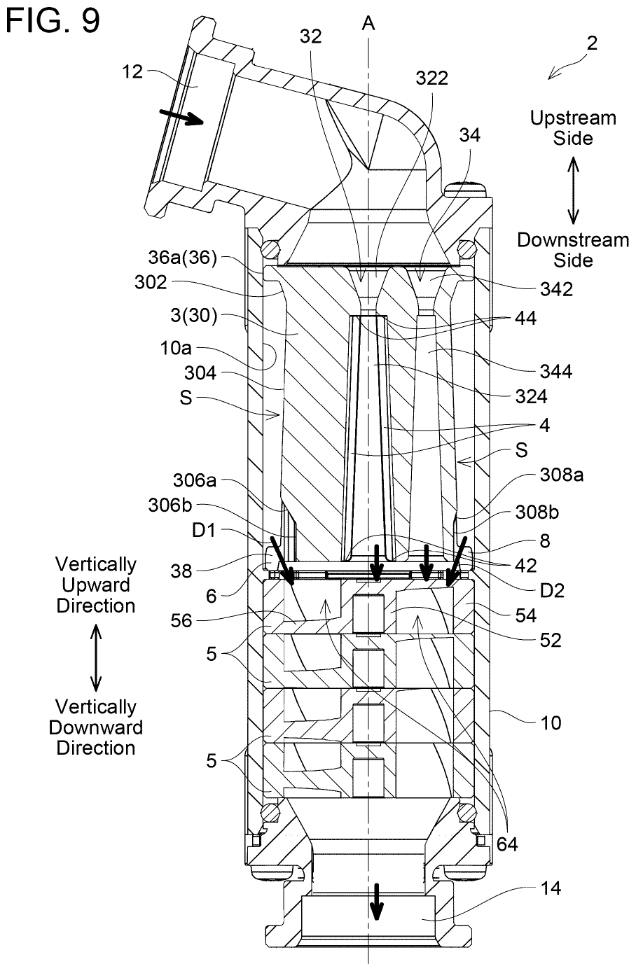

As shown in FIG. 9, the fine bubble generator 2 in this embodiment is set up so that an upstream direction along the central axis A is a vertically upward direction and a downstream direction along the central axis A is a vertically downward direction. Therefore, when the fine bubble generator 2 is drained, the water in the body casing 10 (water in the gap space S) is drained downward by gravity. In other words, as the water drainage proceeds, the water level in the body casing 10 decreases toward the downstream side along the central axis A. In this disclosure, the vertical upward direction may be referred to as “upward” and the vertically downward direction as “downward”.

In the state shown in FIG. 9, the first water drainage flow path D1 is connected to the gap space S at its lowest part or in its vicinity. Similarly, the second water drainage flow path D2 is also connected to the gap space S at its lowest part or in its vicinity. Therefore, when the fine bubble generator 2 is drained, almost all of the water in the gap space S flows into the first water drainage flow path D1 or the second water drainage flow path D2. The term “the vicinity of the lowest part of gap space S” as used herein means the area within L/4 (mm) above the lowest part of the gap space S when the vertical length from the lowest part to the top of the gap space S is defined as L (mm). In this embodiment, the vertical length from the lowest part to the top of gap space S is 40 mm, thus “the vicinity of the lowest part of the gap space S” in this embodiment means the area within 10 mm above the lowest part of the gap space S.

Further, after drainage of the fine bubble generator 2 is performed, a water film may be formed on the diameter-increasing flow paths 324 and 344 of the venturi flow paths 32 and 344 (especially at the downstream ends of the diameter-increasing flow paths 324 and 344 or the vicinities). If the water film in the diameter-increasing flow paths 324 and 344 freeze without being eliminated, the frozen water film may prevent the water from flowing through the fine bubble generator 2, and prompt water supply could be hindered.

In the fine bubble generator 2 of the present embodiment, when a water film is formed on the inner diameter-increasing flow path 324 of the inner venturi flow path 32, the water film is suctioned into the slits 4 and moves upstream along the inner diameter-increasing flow path 324. As shown in FIG. 3, the diameter of the inner diameter-increasing flow path 324 decreases toward the upstream side, so a surface area of the water film decreases as it moves upstream. As the surface area of the water film decreases, the water film is eliminated by, for example, being condensed into water droplets. Thus, in the inner venturi flow path 32, the water film in the inner diameter-increasing flow path 324 can be eliminated. Therefore, even if the water film in the outer diameter-increasing flow paths 344 is not eliminated and freezes after draining, the water film in the inner diameter-increasing flow path 324 is eliminated, thus in at least the inner diameter-increasing flow path 324, water supply is not hindered by frozen water film. Therefore, even when the fine bubble generator 2 is reused after draining, the water can flow immediately, which improves the convenience of the fine bubble generator 2.

### Second Embodiment: Dishwasher 510 Including Fine Bubble Generator 2

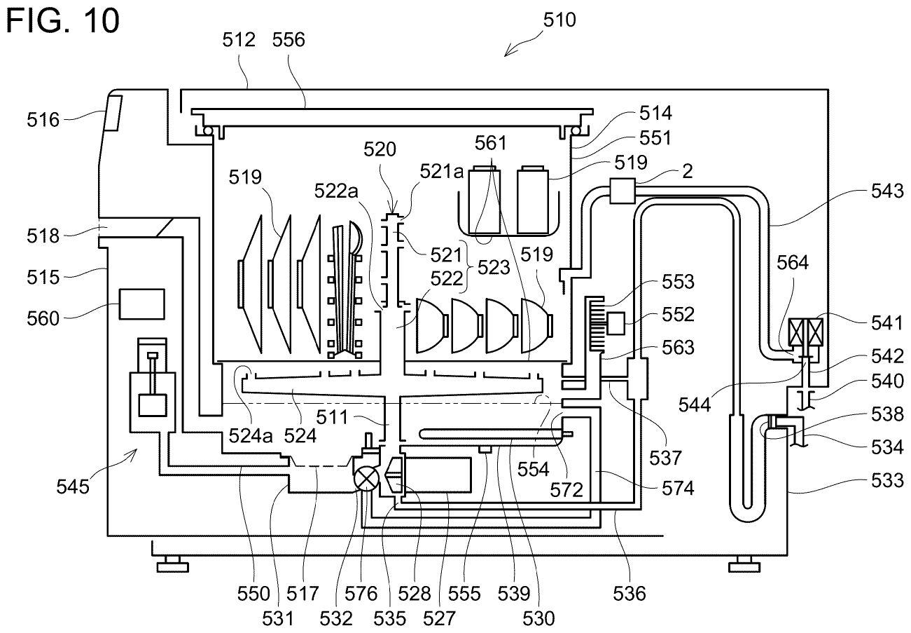

FIG. 10 is a vertical cross-sectional view of a dishwasher 510. The dishwasher 510 is a drawer-type dishwasher. The dishwasher 510 includes a fine bubble generator 2, a body 512, a washing tank 514, a door 515, and a washer controller 560. The fine bubble generator 2 in this embodiment is identical to the fine bubble generator 2 in the first embodiment. For this reason, the explanation of the configuration of the fine bubble generator 2 is omitted in this embodiment.

The door 515 includes an operation panel 516 and an exhaust passage 518. The operation panel 516 is provided with various buttons and lamps, such as a start button. The exhaust passage 518 extends to the outside from the inside of the washing tank 514.

The washing tank 514 is housed in a space defined by the body 512 and the door 515. The washing tank 514 is slidably supported by the body 512. The washing tank 514 is connected to the door 515. The washing tank 514 is formed in a box shape with an open top. A lid 556 is disposed above the washing tank 514. The lid 556 is connected to the washing tank 514 by a lifting mechanism not shown.

A washing nozzle 520, a dish basket 561 for holding various dishes 519, a residue filter 517, a heater 530, a thermistor 555, and the like are housed in the washing tank 514. The washing nozzle 520 is constituted of a tower nozzle section 523 configured of an upper nozzle 521 and a lower nozzle 522, and a horizontal nozzle section 524. The washing nozzle 520 includes a plurality of jet openings 521a, 522a, and 524a. The electric heater 530 is mounted at the vicinity of the bottom 539 of the washing tank 514 to heat the washing water and air in the washing tank 514. The thermistor 555 is mounted on the bottom 539 of the washing tank 514.

At the lowest part of the front outer side of the washing tank 514, a water level detection unit 545 is provided to detect the water level in the washing tank 514. The water level when the washing water is normally supplied to the washing tank 514 (hereinafter referred to as “washing water level”) is indicated by a two-dotted line with a reference number 554. A pump 527 is provided below the bottom 539 of the washing tank 514. The pump 527 uses a built-in electric motor to rotate an impeller 528. The washing nozzle 520 is rotatably mounted on the bottom 539 of the washing tank 514. The washing nozzle 520 and a first discharge port 511 of the pump 527 are connected.

A suction recess 531 is defined in the bottom of the washing tank 514. The upper opening of the suction recess 531 is covered by the residue filter 517. The water level detection unit 545 and the suction recess 531 are connected by a water level path 550. The pump 527 and the suction recess 531 are connected by a first suction flow path 532. One end of a second suction flow path 574 is connected to the first suction flow path 532. The other end of the second suction flow path 574 is connected to an opening 572 of the rear wall 551 of the washing tank 514. A flow path switching valve 576 is mounted at a connection between the first suction flow path 532 and the second suction flow path 574.

A drying fan 552 is mounted on the outside of the rear wall 551 of the washing tank 514. The drying fan 552 rotates a fan 553 using a built-in motor. The drying fan 552 is connected to the inside of the washing tank 514 by a drying passage 563. The drying fan 552 is positioned higher than the washing water level 554.

A drainage hose 534 is connected to the rear wall 533 of the body 512. The drainage hose 534 is connected to a second discharge outlet 535 of the pump 527 by a water drainage flow path 536. A portion of the water drainage flow path 536 and the inside of the washing tank 514 are connected by an air vent passage 537. A drainage check valve 538 is mounted at or in the vicinity of a position where the water drainage flow path 536 is connected to the drainage hose 534.

A water supply hose 540 is connected to a step horizontally formed in the middle of the rear wall 533 of the main body 512. The water supply hose 540 may be fed directly with water supplied from a water supply source such as the water tap (FIG. 4), or may be fed with heated hot water. A water supply valve 541 is mounted inside the rear wall 533. The inlet 544 of the water supply valve 541 is connected to the water supply hose 540 by the first water supply flow path 542. The outlet 564 of the water supply valve 541 is connected to the inside of the washing tank 514 by a second water supply flow path 543. The fine bubble generator 2 is mounted on a portion of the second water supply flow path 543.

The washer controller 560 includes a CPU, ROM, RAM, and the like, and controls operation of the dishwasher 510. By controlling the operation of the dishwasher 510, the washer controller 560 executes a washing operation to wash the dishes 519 in the washing tank 514.

### Washing Operation

Upon receiving an operation to start dishwashing operation from a user on the operation panel 516, the washer controller 560 executes a washing process, a rinsing process, and a drying process in sequence.

During the washing process, the washer controller 560 opens the water supply valve 541 to supply washing water from the water supply hose 540 to the washing tank 514. When the washer controller 560 determines that an amount of washing water required for the washing process has been supplied to the washing tank 514, it closes the water supply valve 541. Next, the washer controller 560 drives the pump 527, rotates the impeller 528 forward, and turns on the heater 530. The washing water is suctioned into the pump 527 from the suction recess 531. The washing water suctioned into the pump 527 is fed into the washing nozzle 520, and is sprayed out from the jet openings 521a, 522a, and 524a with much force. The washer controller 560 ends the washing process after a first predetermined time (e.g., 5 minutes) has elapsed since the washing process started. Further, the washer controller 560 also drives the pump 527 and rotate the impeller 528 in reverse to drain the washing water in the washing tank 514. As described above, the fine bubble generator 2 is installed at a portion of the second water supply flow path 543. The water supplied from the water supply hose 540 contains dissolved air (oxygen, carbon dioxide, nitrogen, etc.). Due to the above, the water that flows through the fine bubble generator 2 and is supplied to the washing tank 514 contains many fine bubbles. Food stains adhered to the dishes 519 are adsorbed onto the surfaces of the fine bubbles in the washing water. By virtue of the washing water containing more fine bubbles, more food stains can be adsorbed.

During the rinsing process, the washer controller 560 opens the water supply valve 541 to supply the washing water from the water supply hose 540 to the washing tank 514. When an amount of washing water required for the rinsing process is supplied to the washing tank 514, the washer controller 560 closes the water supply valve 541. The washer controller 560 drives the pump 527 and rotates the impeller 528 forward. This causes the washing water in the washing tank 514 to be sprayed from the washing nozzle 520 onto the dishes 519 stored in the dish basket 561, and the dishes 519 are thereby rinsed. The washer controller 560 ends the rinsing process after a second predetermined time (e.g., 5 minutes) has elapsed since the rinsing process started. Further, the washer controller 560 also drives the pump 527 to rotate the impeller 528 in reverse to drain the rinsing water in the washing tank 514.

In the drying process, the washer controller 560 heats the air in the washing tank 514 with the heater 530 to dry the dishes 519. When the time elapsed from when drying the dishes 519 is started reaches a third predetermined time, the washer controller 560 terminates heating by the heater 530 and ends the drying process.

### Variants

In the above embodiments, the configuration in which the fine bubble generator 2 includes the second fine bubble generation portions 5 in addition to first fine bubble generation portion 3 was described. In another embodiment, the fine bubble generator 2 may include only the first fine bubble generation portion 3 and may not include the second fine bubble generation portions 5.

In the above embodiments, the configuration in which the inner surface 10a of the body casing 10 has a substantially cylindrical shape was described. In another embodiment, the inner surface 10a of the body casing 10 may not have a substantially cylindrical shape. For example, the inner surface 10a of the body casing 10 may have a square cylindrical shape. In this case, the upstream fitting portion 36, the downstream fitting portion 38, and the outer circumference portions 54 may have the same square cylindrical shape as the inner surface 10a and may substantially fit the inner surface 10a.

In the above embodiments, the configuration in which the body portion 30 includes the diameter-decreasing outer surface 302 and the diameter-increasing outer surface 304 was described. In another embodiment, the body portion 30 may include a cylindrical outer surface centered about the central axis A. The outer surface of the body portion 30 may smoothly connect the outer surface 36a of the upstream fitting portion 36 and the outer surface 38a of the downstream fitting portion 38, and may have a shape that substantially fits the inner surface 10a over the substantially entire inner surface 10a of the body casing 10. In this case, the increased wall thickness of the body portion 30 can improve breakage resistance of the first fine bubble generation portion 3.

In the above embodiments, the configuration in which the first fine bubble generation portion 3 is formed of plastic was described. In another embodiment, the first fine bubble generation portion 3 may be formed of metal (e.g., aluminum or stainless steel). In this case, the first fine bubble generation portion 3 may be constituted of a plurality of parts, and the first fine bubble generation portion 3 may be formed by welding or otherwise adhering the parts together.

In the above embodiments, the configuration in which the plurality of slits 4 is defined substantially linearly from the first end 42 to the second end 44 was described. In another embodiment, the plurality of slits 4 may be defined in a spiral shape around the central axis A from the first end 42 to the second end 44.

In the above embodiments, the configuration in which the second ends 44 of the plurality of slits 4 are located downstream of the downstream end of the inner diameter-decreasing flow path 322 (the second ends 44 coincide with the upstream end of the inner diameter-increasing flow path 324) was described. In another embodiment, the second ends 44 may extend to a position upstream of the downstream end of the inner diameter-decreasing flow path 322. For example, the second ends 44 may coincide with the upstream end of the inner diameter-decreasing flow path 322. In this case, an amount of fine bubbles in the inner venturi flow path 32 is reduced, but the water film is more reliably eliminated. In yet another example, the second ends 44 may be located downstream of the upstream end of the inner diameter-increasing flow path 324.

In the above embodiments, the configuration in which the plurality of slits 4 is defined in the inner venturi flow path 32 and not in the plurality of outer venturi flow paths 34 was described. In another embodiment, the plurality of slits 4 may not be defined in the inner venturi flow path 32, but may be defined in the plurality of outer venturi flow paths 34. In this case, the plurality of slits 4 may be defined in at least one of the plurality of outer venturi flow paths 34. In yet another example, the plurality of slits 4 may be defined in both the inner venturi flow path 32 and the plurality of outer venturi flow paths 34.

In the above embodiments, the configuration in which both the first notch 6 and the first recess 306 (or the second notch 8 and the second recess 308) serve as the first water drainage flow path D1 (or the second water drainage flow path D2). In another embodiment, one of the first notch 6 and the first recess 306 (or the second notch 8 and the second recess 308) may not be provided. In this case, only the other of first notch 6 and the first recess 306 (or the second notch 8 and the second recess 308) may serve as the first water drainage flow path D1 (or the second water drainage flow path D2). In yet another embodiment, instead of the first notch 6 and the first recess 306 (or the second notch 8 and the second recess 308) being defined, a recess which is recessed inwardly from the outer surface 38a of the downstream fitting portion 38 may be defined. In this case, the recess in the downstream fitting portion 38 may serve as the first water drainage flow path D1 (or the second water drainage flow path D2).

In the above embodiments, the configuration in which the first water drainage flow path D1 (or the second water drainage flow path D2) is defined by removing (or recessing) the first fine bubble generation portion 3 was described. In another embodiment, the first water drainage flow path D1 (or the second water drainage flow path D2) may be defined by recessing the body casing 10 from the inner surface 10a outward in the radial direction of the central axis A.

In the above embodiments, the configuration in which the fine bubble generator 2 is installed such that the upstream direction along the central axis A is a vertically upward direction and the downstream direction along the central axis A is a vertically downward direction was described. In another embodiment, the fine bubble generator 2 may not be installed as such. For example, the fine bubble generator 2 may be installed such that the upstream direction along the central axis A is tilted within an angle range of −90° to 90° with respect to the vertically upward direction and the downstream direction along the central axis A is tilted within an angle range of −90° to 90° with respect to the vertically downward direction. In this case, either the first water drainage flow path D1 or the second water drainage flow path D2 may be arranged to connect to the gap space S at the lowest part or in the vicinity thereof. In this case as well, when the fine bubble generator 2 is drained, almost all of the water in the gap space S flows into the first water drainage flow path D1 or the second water drainage flow path D2.

In the above embodiments, the configuration with two water drainage flow paths was described. In another embodiment, three or more water drainage flow paths may be provided. Further, only one water drainage flow path may be provided.

In the above embodiments, the numbers of the plurality of second fine bubble generation portions 5, the plurality of outer venturi flow paths 34, the plurality of slits 4, and the plurality of vanes 56 may suitably be changed. In addition, although described as “plurality”, the numbers of these components may be one.

### Corresponding Relationship

In one or more embodiments, the fine bubble generator 2 comprises the body casing 10 having the inlet 12 and the outlet 14, and the first fine bubble generation portion 3 housed in the body casing 10. The first fine bubble generation portion 3 comprises the body portion 30 extending between the inlet 12 and the outlet 14, the venturi flow paths 32, 34 connecting the inlet 12 and the outlet 14 through the body portion 30, the upstream fitting portion 36 connected to the upstream end of the body portion 30 and including the outer surface 36a having the shape that substantially fits the inner surface 10a of the body casing 10 when the interior of the body casing 10 is viewed from the upstream side, and the downstream fitting portion 38 connected to the downstream end of the body portion 30 and including the outer surface 38a having the shape that substantially fits the inner surface 10a of the body casing 10 when the interior of the body casing 10 is viewed from the downstream side. The venturi flow paths 32, 34 comprise the diameter-decreasing flow paths 322, 342 of which flow path diameter decreases from upstream to downstream, and the diameter-increasing flow paths 324, 344 disposed downstream of the diameter-decreasing flow paths 322, 342 and of which flow path diameter increases from upstream to downstream. The gap space S and the first water drainage flow path D1 and the second water drainage flow path D2 (examples of one or more liquid water drainage flow paths) are disposed in the body casing 10, in which the gap space S is defined between the inner surface 10a of the body casing 10 and the diameter-decreasing outer surface 302 and the diameter-increasing outer surface 304 (examples of outer surface of the body portion) and between the upstream fitting portion 36 and the downstream fitting portion 38, and each of the first water drainage flow path D1 and the second water drainage flow path D2 connect the gap space S to the outlet 14.

According to the above configuration, when the fine bubble generator 2 is drained so that the water in body casing 10 drains from the inlet 12 to the outlet 14, the water in the gap space S drains to the outlet 14 through the first water drainage flow path D1 or the second water drainage flow path D2. Due to this, the draining performance of the gap space S can be improved.

In one or more embodiments, the water drainage flow paths comprise a plurality of water drainage flow paths and comprises the first water drainage flow path D1 and the second water drainage flow path D2.

According to the above configuration, when the fine bubble generator 2 is drained so that the water in the body casing 10 drains from the inlet 12 to the outlet 14, the water in the gap space S drains from two locations to the outlet 14. Due to this, the draining performance of the gap space S can further be improved.

In one or more embodiments, at least one of the first water drainage flow path D1 and the second water drainage flow path D2 are connected to the gap space S at the lowest part of the gap space S or in the vicinity thereof when the lower side is defined with respect to the vertically downward direction.

Normally, when the fine bubble generator 2 is drained, the water in the gap space S drains downward by gravity. Due to this, especially at the lowest part of the gap space S or in the vicinity thereof, water puddle tends to occur after drainage of the fine bubble generator 2. According to the above configuration, the first water drainage flow path D1 and the second water drainage flow path D2 (examples of at least one water drainage flow path) are connected to the gap space S at the lowest part of the gap space S or in the vicinity thereof when the lower side is defined with respect to the vertically downward direction. This ensures that the occurrence of the water puddle in the gap space S after drainage of the fine bubble generator 2 is suppressed.

In one or more embodiments, the fine bubble generator 2 further comprises the second fine bubble generation portions 5 housed in the body casing 10 and disposed between the first fine bubble generation portion 3 and the outlet 14. The second fine bubble generation portions 5 comprise the shaft portion 52 extending in the direction from upstream to downstream, the outer circumference portions 54 surrounding the outside of the shaft portion 52 in the radial direction, the plurality of vanes 56 disposed between the shaft portion 52 and the outer circumference portions 54 and configured to generate the swirling flow that flows in the clockwise direction (example of predetermined direction) with respect to the shaft portion 52, and the swirling flow paths 64 that extend through the space between the shaft portion 52, the outer circumference portions 54, and the plurality of vanes 56.

According to the above configuration, the second fine bubble generation portions 5 are further provided downstream of the first fine bubble generation portion 3. Therefore, the water flowing into the inlet 12 not only passes through the venturi flow paths 32 and 34 of the first fine bubble generation portion 3, but also through the swirling flow paths 64 of the second fine bubble generation portions 5. In this case, the fine bubbles generated in the first fine bubble generation portion 3 become finer and the amount of fine bubbles increases due to the shear force by the swirling flow generated in the second fine bubble generation portions 5. According to the above configuration, a large amount of fine bubbles can be generated.

In one or more embodiments, the body casing 10 includes the inner surface 10a having a substantially cylinder shape extending in the direction from upstream to downstream. The first fine bubble generation portion 3 is constituted of a plastic. The body portion 30 includes the diameter-decreasing outer surface 302 of which diameter decreases from upstream to downstream at a portion where the diameter-decreasing flow paths 322, 342 are disposed. The body portion 30 includes the diameter-increasing outer surface 304 of which diameter increases from upstream to downstream at a portion where the diameter-increasing flow paths 324, 344 are disposed.

When plastic is used for the first fine bubble generation portion 3, the first fine bubble generation portion 3 is generally formed by injection molding. In this case, if the wall thickness of the first fine bubble generation portion 3 (especially the body portion 30) is large, qualitative defects of the first fine bubble generation portion 3 are likely to occur. Contrary to this, according to the above configuration, the wall thickness of the body portion 30 can be reduced. Therefore, when the first fine bubble generation portion 3 is formed by injection molding, the quality of the first fine bubble generation portion 3 can be improved. Furthermore, according to the above configuration, the volume of the gap space S is increased, and the effect of improving the drainage performance of the gap space S achieved by the present application becomes more remarkable.

In one or more embodiments, the first notch 6 and the second notch 8 (examples of one or more notches) are disposed in the first fine bubble generation portion 3 by removing portions of the downstream fitting portion 38 from downstream to upstream. The first notch 6 and the second notch 8 serve as the first water drainage flow path D1 and the second water drainage flow path D2.

According to the above configuration, the first water drainage flow path D1 and second water drainage flow path D2 can be defined by partially processing the first fine bubble generation portion 3. Therefore, the first water drainage flow path D1 and the second water drainage flow path D2 can be easily defined.

In one or more embodiments, the first recess 306 and second recess 308 (examples of one or more recesses) are disposed in the first fine bubble generation portion 3, each of the recesses 306 and 308 has a shape recessed inwardly from the diameter-increasing outer surface 304. The first recess 306 and second recess 308 are connected to the first notch 6 and the second notch 8.

According to the above configuration, the first recess 306 and second recess 308 make it easier for water in the gap space S to be directed to first notch 6 and second notch 8. That is, the water in the gap space S tends to be directed to the first water drainage flow path D1 and the second water drainage flow path D2. Therefore, the drainage performance of the gap space S can be further improved.

In one or more embodiments, the water heater 100 comprises the fine bubble generator 2.

According to the above configuration, the drainage performance of the gap space S can be improved in the fine bubble generator 2 included in the water heater 100.

In one or more embodiments, the dishwasher 510 comprises the fine bubble generator 2.

According to the above configuration, the drainage performance of the gap space S can be improved in the fine bubble generator 2 included in the dishwasher 510.

Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

1. A fine bubble generator comprising:
a body casing having an inlet and an outlet; and
a first fine bubble generation portion housed in the body casing,
wherein
the first fine bubble generation portion comprises:
a body portion extending between the inlet and the outlet;
a venturi flow path connecting the inlet and the outlet through the body portion;
an upstream fitting portion connected to an upstream end of the body portion and including an outer surface having a shape that substantially fits an inner surface of the body casing when an interior of the body casing is viewed from an upstream side; and
a downstream fitting portion connected to a downstream end of the body portion and including an outer surface having a shape that substantially fits the inner surface of the body casing when the interior of the body casing is viewed from a downstream side,
the venturi flow path comprises:
a diameter-decreasing flow path of which flow path diameter decreases from upstream to downstream; and
a diameter-increasing flow path which is disposed downstream of the diameter-decreasing flow path and of which flow path diameter increases from upstream to downstream, and
a gap space and one or more liquid drainage flow paths are disposed in the body casing, wherein the gap space is defined between the inner surface of the body casing and an outer surface of the body portion and between the upstream fitting portion and the downstream fitting portion, and each of the one or more liquid drainage flow paths connects the gap space to the outlet.

2. The fine bubble generator according to claim 1, wherein
the liquid drainage flow paths comprise a plurality of liquid drainage flow paths and comprise a first liquid drainage flow path and a second liquid drainage flow path.

3. The fine bubble generator according to claim 1 or 2, wherein
at least one of the one or more liquid drainage flow paths is connected to the gap space at a lowest part of the gap space or in a vicinity thereof when a lower side is defined with respect to a vertically downward direction.

4. The fine bubble generator according to any of claims 1 to 3, further comprising a second fine bubble generation portion housed in the body casing and disposed between the first fine bubble generation portion and the outlet,
wherein
the second fine bubble generation portion comprises:
a shaft portion extending in a direction from upstream to downstream;
an outer circumference portion surrounding an outside of the shaft portion in a radial direction;
a plurality of vanes disposed between the shaft portion and the outer circumference portion and configured to generate a swirling flow flowing in a predetermined swirling direction with respect to the shaft portion; and
a swirling flow path extending through a space between the shaft portion, the outer circumference portion, and the plurality of vanes.

5. The fine bubble generator according to any of claims 1 to 4, wherein
the body casing includes an inner surface having a substantially cylinder shape extending in a direction from upstream to downstream,
the first fine bubble generation portion is constituted of a plastic,
the body portion includes a diameter-decreasing outer surface of which diameter decreases from upstream to downstream at a portion where the diameter-decreasing flow path is disposed, and
the body portion includes a diameter-increasing outer surface of which diameter increases from upstream to downstream at a portion where the diameter-increasing flow path is disposed.

6. The fine bubble generator according to any of claims 1 to 5, wherein
one or more notches are disposed in the first fine bubble generation portion, each of the notches is defined by removing a portion of the downstream fitting portion from downstream to upstream, and
the one or more notches serve as the one or more liquid drainage flow paths.

7. The fine bubble generator according to claim 6, wherein
one or more recesses are disposed in the first fine bubble generation portion, each of the recesses has a shape recessed inwardly from the outer surface of the body portion, and
the one or more recesses are connected to the one or more notches.

8. A water heater comprising the fine bubble generator according to any of claims 1 to 7.

9. A dishwasher comprising the fine bubble generator according to any of claims 1 to 7.
